(19) United States
(12) Patent Application Publication
(10) Pub. No.: US 2022/0180058 A1
(43) Pub. Date: Jun. 9, 2022

(54) TEXT ERROR CORRECTION METHOD, APPARATUS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Ruiqing ZHANG, Beijing (CN); Chuanqiang ZHANG, Beijing (CN); Zhongjun HE, Beijing (CN); Zhi LI, Beijing (CN); Hua WU, Beijing (CN)

(73) Assignee: BEIJING BAIDU NETCOM SCIENCE AND TECHNOLOGY CO., LTD., Beijing (CN)

(21) Appl. No.: 17/383,611

(22) Filed: Jul. 23, 2021

(30) Foreign Application Priority Data
Dec. 8, 2020 (CN) 202011445288.5

(51) Int. Cl. G06F 40/232; G06F 40/40; G06F 40/253

(52) U.S. Cl. CPC G06F 40/232; G06F 40/253; G06F 40/40

(57) ABSTRACT

The present disclosure provides a text error correction method, apparatus, electronic device and storage medium, and relates to the technical field of artificial intelligence such as natural language processing and deep learning. A specific implementation solution is: obtaining a current sentence and a historical sentence of the current sentence in an article to which the current sentence belongs; performing text error correction processing on the current sentence based on the current sentence and the historical sentence. According to the technical solutions of the present disclosure, text error correction can be performed on the current sentence based on the historical sentence, namely, the upper contextual information, of the current sentence in the article, so that the error correction information is richer and the error correction result is more accurate.

### CROSS-REFERENCE TO RELATED APPLICATIONS

The present application claims the priority of Chinese Patent Application No. 202011445288.5, filed on Dec. 8, 2020, with the title of “Text error correction method, apparatus, electronic device and storage media.” The disclosure of the above application is incorporated herein by reference in its entirety.

### TECHNICAL FIELD

The present disclosure relates to technical field of computers, particularly to the technical field of artificial intelligence such as natural language processing and deep learning, and specifically to a text error correction method, apparatus, electronic device and storage medium.

### BACKGROUND

Natural Language Processing (NLP) is an important branch of the field of computer science and the field of artificial intelligence.

Text error correction is a fundamental issue in NLP, and may usually be placed before other NLP tasks such as text retrieval, text classification, machine translation or sequence tagging, to improve validity of an input text and prevent an adverse impact caused by a misspelling error. A conventional mainstream text error correction principle is to segment a paragraph of text with sentences as granularity. For each sentence after segmentation, a cascade method is employed for error correction. For example, error detection is performed first, i.e., detect which characters in the sentence are wrong; then candidates for errors are generated, i.e., possible correct candidate characters are generated for each detected wrong character; finally, screening of candidates is performed, i.e., a final correct character is obtained by screening for each of the generated candidate characters.

### SUMMARY

The present disclosure provides a text error correction method, apparatus, electronic device and storage medium.

According to a first aspect, there is provided a text error correction method, including: obtaining a current sentence and a historical sentence of the current sentence in an article to which the current sentence belongs; performing text error correction processing on the current sentence based on the current sentence and the historical sentence.

According to a second aspect, there is provided an electronic device, including: at least one processor; and a memory communicatively connected with the at least one processor; wherein the memory stores instructions executable by the at least one processor, and the instructions are executed by the at least one processor to enable the at least one processor to perform a text error correction method, wherein the method includes: obtaining a current sentence and a historical sentence of the current sentence in an article to which the current sentence belongs; performing text error correction processing on the current sentence based on the current sentence and the historical sentence.

According to a third aspect, there is provided anon-transitory computer readable storage medium with computer instructions stored thereon, wherein the computer instructions are used for causing a computer to perform a text error correction method, wherein the method includes: obtaining a current sentence and a historical sentence of the current sentence in an article to which the current sentence belongs; performing text error correction processing on the current sentence based on the current sentence and the historical sentence.

According to the technical solutions of the present disclosure, text error correction can be performed on the current sentence based on the historical sentence, namely, the upper contextual information, of the current sentence in the article, so that the error correction information is richer and the error correction result is more accurate.

It will be appreciated that the Summary part does not intend to indicate essential or important features of embodiments of the present disclosure or to limit the scope of the present disclosure. Other features of the present disclosure will be made apparent by the following description.

### BRIEF DESCRIPTION OF THE DRAWINGS

The figures are intended to facilitate understanding the solutions, not to limit the present disclosure. In the figures,

FIG. 1 illustrates a schematic diagram of a first embodiment according to the present disclosure;

FIG. 2 illustrates a schematic diagram of a second embodiment according to the present disclosure;

FIG. 3 illustrates a schematic diagram of a third embodiment according to the present disclosure;

FIG. 4 illustrates a schematic diagram of an encoding principle in a text error correction method according to the present disclosure;

FIG. 5 illustrates a schematic diagram of a fourth embodiment according to the present disclosure;

FIG. 6 illustrates a schematic diagram of a fifth embodiment according to the present disclosure;

FIG. 7 illustrates a block diagram of an electronic device for implementing the text error correction method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

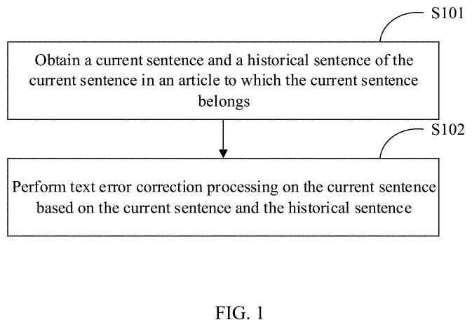

FIG. 1 illustrates a schematic diagram of a first embodiment according to the present disclosure; as shown in FIG. 1, the present embodiment provides a text error correction method and may specifically comprises the following steps:

S101: obtaining a current sentence and a historical sentence of the current sentence in an article to which the current sentence belongs;

S102: performing text error correction processing on the current sentence based on the current sentence and the historical sentence.

A subject for performing the text error correction method in the present embodiment may be a text error correction apparatus which may be a physical electronic device a, or may be a software integrated application. When applying the method, text error correction processing can be performed on the current sentence based on the current sentence and the historical sentence in the same article as the current sentence.

The historical sentence in the present embodiment is all the sentences before the current sentence in the article. Alternatively, when the article is particularly long, N continuous sentences which are closet neighboring before the current sentence may be taken from the article as the historical sentences. For example, N here may be 8, 10, 20 or other positive integers according to actual needs, which are not listed one by one here. The historical sentence may also be referred to as upper contextual information of the current sentence because it is located in the upper context of the current sentence in the article.

It may be known from the above that preferably, the current sentence of the present embodiment cannot be the first sentence of an article. Since the first sentence of the article does not have the upper contextual information, the technical solution of present embodiment cannot be employed to perform text error correction processing on the current sentence based on the historical sentence and current sentence. Alternatively, in practical application, the first sentence in the article may also be taken as the current sentence, and in this case the historical sentence is set as empty.

For example, sentences in the following Table 1 are taken as examples to illustrate the technical solution of the present embodiment.

TABLE 1

| Sentence No. | S₁ | S₂ | S₃ |
|---|---|---|---|
| Source text | Not easy. | This tongue twister is a matter | See if your mouth is |
| | [symbol] | of opening your mouth. [symbol] | advantageous. [symbol] |
| | | [symbol] [symbol] | [symbol] ) |
| | | [symbol] ) | |
| Correct text | Not easy. | This tongue twister is a matter | See if your mouth is |
| | [symbol] | of opening your mouth. [symbol] | fluent. [symbol] |
| | | [symbol] [symbol] | [symbol] ) |
| | | [symbol] ) | |

In the above Table 1, S₃ is the current sentence, and S₁ and S₂ are historical sentences of the current sentence. The first line is the source text, and the second line is a text corrected using technical solution of the present embodiment. When error correction is performed without reference to the historical sentences by using a conventional technical solution, it is not possible to determine whether the current sentence is wrong and whether the current sentence needs to be corrected by separately analyzing the current sentence S₃ “See if your mouth is advantageous”. If the technical solution of the present embodiment is employed to analyze the current sentence S₃ “See if your mouth is advantageous” by referring to S₁ “not easy” and S₂ “This tongue twister is a matter of opening your mouth”, the current sentence may be corrected at this time. As shown in the above Table 1, “advantageous” in S₃ may be corrected to “fluent” when correcting error.

According to the text error correction method of the present embodiment, the current sentence and the historical sentence of the current sentence in the article to which the current sentence belongs are obtained; text error correction processing is performed on the current sentence based on the current sentence and the historical sentence. By the method, text error correction can be performed on the current sentence based on the historical sentence, namely, the upper contextual information, of the current sentence in the article so that the error correction information is richer and the error correction result is more accurate.

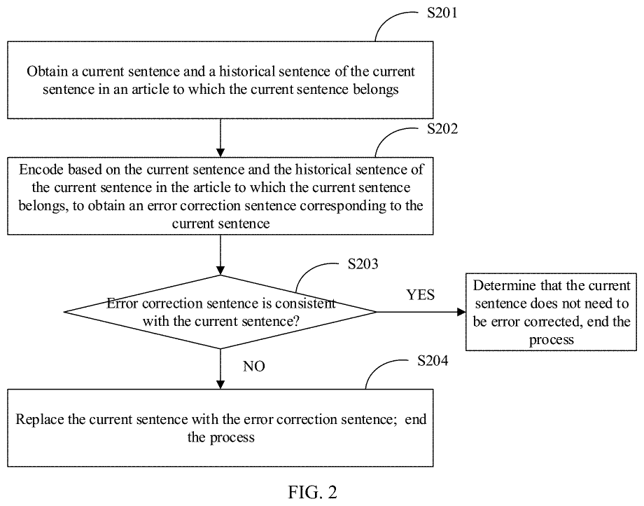

FIG. 2 illustrates a schematic diagram of a second embodiment according to the present disclosure; as shown in FIG. 2, the text error correction method of the present embodiment, based on the technical solution of the embodiment shown in FIG. 1, further describes the technical solution of the present disclosure in more detail. As shown in FIG. 2, the text error correction method of present embodiment may specifically include the following steps:

S201: obtaining a current sentence and a historical sentence of the current sentence in an article to which the current sentence belongs;

S202: encoding based on the current sentence and the historical sentence of the current sentence in the article to which the current sentence belongs, to obtain an error correction sentence corresponding to the current sentence;

S203: detecting whether the error correction sentence is consistent with the current sentence; if they are inconsistent, performing step S204; if they are consistent, determining that the current sentence does not need to be error corrected, and ending the process.

S204: replacing the current sentence with the error correction sentence; ending the process.

Steps S202-S204 of the present embodiment are implementation manner of step S102 of the embodiment shown in FIG. 1.

In the present embodiment, any current sentence in the article is taken as an example to perform text error correction processing. In actual applications, according to the technical solution of the present embodiment, each sentence in the article is taken as the current sentence for text error correction processing, thereby implementing the text error correction processing for all sentences except the first sentence of the article.

In addition, optionally, in the implementation process of steps S202-S204 of the present embodiment, a pre-trained text error correction model may be employed to perform text error correction processing on the current sentence based on the current sentence and historical sentence.

For example, when the text error correction model is used for text error correction processing, input to the text error correction model is the current sentence and the historical sentence corresponding to the current sentence. In the text error correction model, encoding may be performed based on the current sentence and the historical sentence of the current sentence in the article to which the current sentence belongs, to obtain an error correction sentence corresponding to the current sentence. Then the error correction sentence is compared with the current sentence to judge whether the two are consistent. If the error correction sentence and the current sentence are inconsistent, it is determined that the current sentence needs to be corrected, and the current sentence can be directly replaced with the error correction sentence. Otherwise, if the error correction sentence and the current sentence are consistent, it is determined that the current sentence needn't be error corrected. Optionally, the above solution may also be implemented independently of the text error correction model with the same implementation principle, which will not be detailed any more here.

According to the text error correction method of the present embodiment and the above technical solution, text error correction can be performed on the current sentence based on the historical sentence, namely, the upper contextual information, of the current sentence in the article, so that the error correction information is richer and the error correction result is more accurate. Furthermore, the text error correction solution of the present embodiment may be implemented based on a pre-trained text error correction model, thereby further improving the intelligence and accuracy of text error correction.

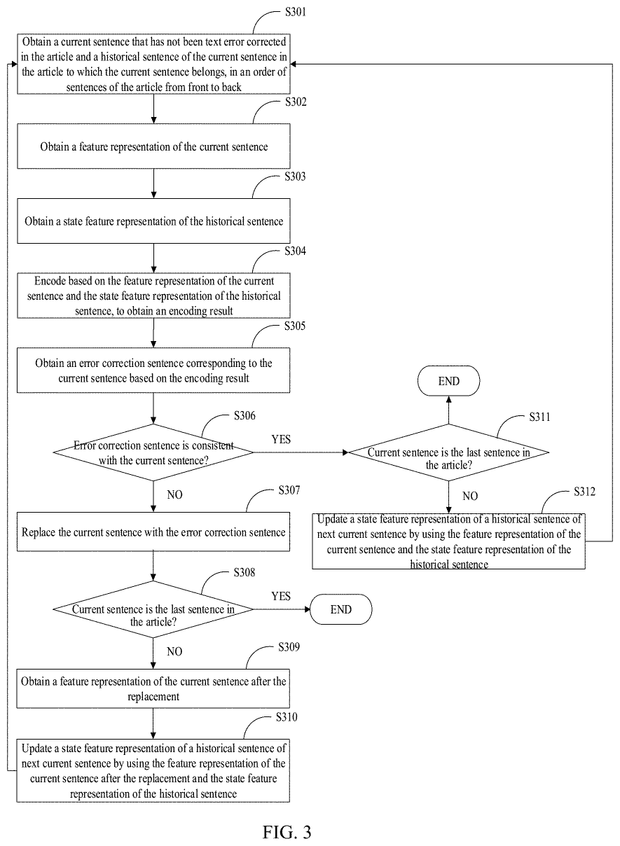

FIG. 3 illustrates a schematic diagram of a third embodiment according to the present disclosure; as shown in FIG. 3, the text error correction method of present embodiment, on the basis of the technical solution of the embodiment shown in FIG. 2, further describes the technical solution of the present application in more detail. As shown in FIG. 3, the text error correction method of the present embodiment may specifically include the following steps:

S301: obtaining a current sentence that has not been text error corrected in the article and a historical sentence of the current sentence in the article to which the current sentence belongs, in an order of sentences of the article from front to back;

When the current sentence in the present embodiment is the first sentence in the article, the historical sentence is empty. When the current sentence is a sentence other than the first sentence, the historical sentence is all the sentences before the current sentence in the article. Specifically, in the order from front to back, each sentence is sequentially obtained as the current sentence, and text error correction is performed according to the technical solution of the present embodiment.

S302: obtaining a feature representation of the current sentence;

For example, optionally, from this step to step S309, a text error correction process may be implemented by using a pre-trained text error correction model. At this time, the current sentence and historical sentence obtained in step S301 may be input into the text error correction model.

Specifically, each character in the current sentence may be represented as a vector, e.g., may be represented as a 1×d vector. For T characters in the current sentence, a feature representation of the current sentence may be obtained as a T×d matrix. It needs to be appreciated that that network parameters used for vector representation of each character are also determined when pre-training the text error correction model.

S303: obtaining a state feature representation of the historical sentence;

In the present embodiment, since the historical sentence is long enough and includes many sentences, the state feature representation of the historical sentence may be identified by a 1×d vector. Specifically, a recurrent convolutional neural network may be employed to encode the historical sentence to obtain the state feature representation of the historical sentence.

S304: encoding based on the feature representation of the current sentence and the state feature representation of the historical sentence, to obtain an encoding result;

In the present embodiment, in the process of encoding based on the feature representation of the current sentence and the state feature representation of the historical sentence, the state feature representation of the historical sentence and the feature representation of the current sentence may be concatenated together to obtain a (1+T)×d matrix. Then an encoder may be employed to encode the matrix, to obtain an encoding result and output the encoding result. The encoding result is also a (1+T)×d matrix. For example, the encoder of the present embodiment may employ a transformer encoder.

S305: obtaining an error correction sentence corresponding to the current sentence based on the encoding result;

For example, in the above encoding result (1−T)×d matrix, an encoding result of the state feature representation of the historical sentence is at the first position. An encoding result of the feature representation of the current sentence is at subsequent T positions. Then a full connection f_{corr} is connected after the encoding result at the subsequent T positions, to perform error correction for each character to thereby obtain the error correction sentence corresponding to the current sentence.

Steps S302-S305 in the present embodiment are implementation mode of step S202 in the embodiment shown in the above FIG. 2.

S306: detecting whether the error correction sentence is consistent with the current sentence; performing step S307 if they are inconsistent; performing step S311 if they are consistent, ending the process.

S307: replacing the current sentence with the error correction sentence; performing step S308;

S308: judging whether the current sentence is the last sentence in the article, and ending the process if YES; performing step S309 if NO;

S309: obtaining a feature representation of the current sentence after the replacement; performing step S310;

S310: updating a state feature representation of a historical sentence of next current sentence by using the feature representation of the current sentence after the replacement and the state feature representation of the historical sentence, and returning to step S301 to continue to perform text error correction;

S311: judging whether the current sentence is the last sentence in the article, and ending the process if YES; performing step S312 if NO;

S312: updating a state feature representation of a historical sentence of next current sentence by using the feature representation of the current sentence and the state feature representation of the historical sentence, and returning to step S301 to continue to perform text error correction.

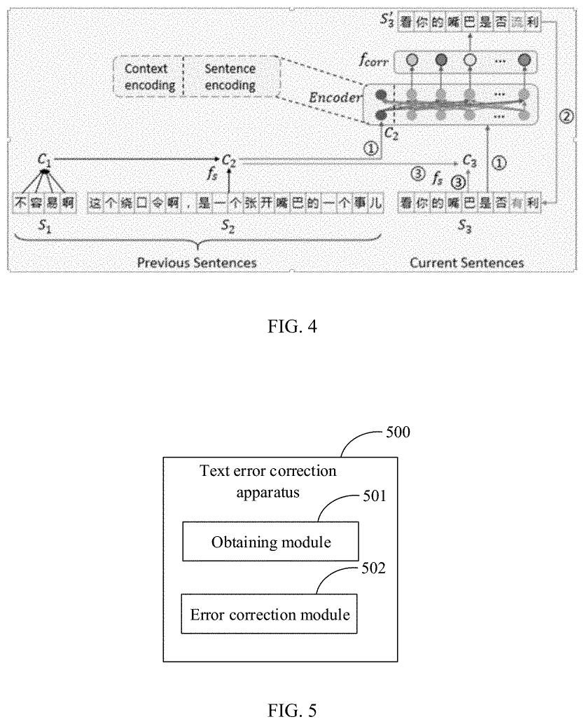

For example, FIG. 4 illustrates a schematic diagram of an encoding principle in a text error correction method according to the present disclosure. As shown in FIG. 4, taking the source text of the above Table 1 as an example, where S₃ is any current sentence in the article, and S₁ and S₂ are historical sentences of the current sentence S₃.

The execution process of step S304 may be represented by the following Formula (1):

S′ᵢ←f_{corr}(Encoder(Cᵢ₋₁, Sᵢ)) (1)

where Encoder(C₁₋₁, Sᵢ) represents encoding based on the current sentence Sᵢ and the historical sentence Cᵢ₋₁. As shown in the above embodiment, specifically, encoding is performed based on a feature representation of a current sentence Sᵢ and a state feature representation of a historical sentence Cᵢ₋₁, then last T bits of the encoding result are taken, and a full connection f_{corr} is used for processing to obtain an error correction sentence S′ᵢ of the current sentence. Cᵢ₋₁∈R^{d} means that the state feature representation of the historical sentence Cᵢ₋₁ is represented by a 1×d dimensional vector; Sᵢ∈R^{T×d} means that the feature representation of the current sentence Sᵢ is represented by a T×d dimensional matrix.

Then, detection is further performed as to whether the error correction sentence is consistent with the current sentence; if they are inconsistent, the following formula (2) is used for error correction processing:

Sᵢ←S′ᵢ (2)

As shown in FIG. 4, after error correction is performed for the current sentence S₃ “see if your mouth is advantageous”, the obtained S′₃ ′ is “see if your mouth is fluent”. That is, correspondingly, S₃←S′₃ is employed.

Furthermore, since it is necessary to further perform error correction for the next sentence after the current sentence, the historical sentences need to be updated accordingly. Correspondingly, S₄ will appear at this time. Correspondingly, S₁, S₂, and S₃ are taken as the historical sentences of the current sentence S₄, and so on, to realize the error correction of the current sentence S₄.

Specifically, the state feature representation of the updated history sentences may be represented by the following formula:

Cᵢ←fₛ(Cᵢ₋₁,Sᵢ) (3)

For example, the first position in the last layer of the Encoder may be taken as the state feature representation of the historical sentence after Sᵢ is read, and used to update Cᵢ. That is to say, the implementation of fₛ is defined as Encoder(Cᵢ₋₁, Sᵢ) [1,:].

It needs to be appreciated that if text error correction does not happen to the current sentence Sᵢ, the Sᵢ employed when updating the state feature representation of the historical sentence Cᵢ of next current sentence Sᵢ₊₁ in formula (3) is the same as that in formula (1). If the text error correction happens to the current sentence Sᵢ, error correction replacement has been performed in the formula (2) correspondingly. At this time, the Sᵢ in the formula (3) is the S′ᵢ i in the above formula (1).

In addition, it should be appreciated that the text error correction model in the above embodiment is a neural network model, which may be an end-to-end model. When applying the model, the current sentence and historical sentence obtained in step S301 are input, and correspondingly, the error correction sentence and the state feature representation of the updated historical sentence of next current sentence are output. Alternatively, the state feature representation of the updated historical sentence of next current sentence may not be output to the external, and may be directly invoked when text error correction is performed for next current sentence. It also needs to be appreciated that the text error correction model needs to be pre-trained before being used. The pre-training process is similar to the use process of the above model in principle. The only thing is that the training of the text error correction model is supervised training, and training samples need to be constructed in advance. The sentences in the above Table 1 are still taken as an example to construct a plurality of training samples shown in the following Table 2.

TABLE 2

| | | | [Standard error correction |
|---|---|---|---|
| [Training | | | sentence corresponding to |
| sample ID] | [Historical sentence] | [Current sentence] | the current sentence |
| 1 | | Not easy. [symbol] | Not easy. [symbol] ) |
| | | [symbol] ) | |
| 2 | Not easy. | This tongue twister | This tongue twister is a |
| | [symbol] ) | is a matter of | matter of opening your |
| | | opening your | mouth. [symbol] |
| | | mouth. [symbol] | [symbol] |
| | | [symbol] | [symbol] ) |
| | | [symbol] ) | |
| 3 | Not easy. This tongue | See if your mouth is | See if your mouth is fluent. |
| | twister is a matter of | advantageous. [symbol] | [symbol] ) |
| | opening your | [symbol] | |
| | mouth. [symbol] | [symbol] ) | |
| | [symbol] | | |
| | [symbol] | | |
| | [symbol] ) | | |
| . . . | . . . | . . . | . . . |

When the training samples are constructed, each sentence in the article may be taken as the current sentence, and the sentences before the current sentence are the historical sentences. For partial current sentences, corresponding standard error correction sentences may be themselves. For partial current sentences, error samples may be constructed, i.e., erroneous current sentences may be generated, and correct standard error correction sentences are may be used for error correction training, as shown in the above training sample 3.

When training the model, each training sample is used to train the text error correction model, and the current sentence, historical sentence and standard error correction sentence corresponding to the current sentence in each training sample are input into the text error correction model. The text error correction model first performs error correction processing based on the current sentence and the historical sentences to obtain a predicted error correction sentence. Then, a loss function is constructed based on the predicted error correction sentence and the standard error correction sentence, and parameters of the text error correction model are adjusted by a gradient descent method. For example, the parameters of the text error correction model of the present embodiment may include network parameters for performing feature representation for the current sentence, network parameters for performing state feature representation for the historical sentence, encoding parameters for encoding, parameters of a fully-connected network layer for producing the error correction sentence, etc. The training samples are used to continuously train the text error correction model until the loss function converges, the parameters of the text error correction model are determined, and then the text error correction model is determined.

According to the text error correction method of the present embodiment and the above technical solution, text error correction can be performed on the current sentence based on the historical sentence, namely, the upper contextual information, of the current sentence in the article, so that the error correction information is richer and the error correction result is more accurate. Furthermore, the text error correction solution of the present embodiment may be implemented based on a pre-trained text error correction model, thereby further improving the intelligence and accuracy of text error correction.

FIG. 5 illustrates a schematic diagram of a fourth embodiment according to the present disclosure; as shown in FIG. 5, the present embodiment provides a text error correction apparatus 500 which may specifically include:

an obtaining module 501 configured to obtain a current sentence and a historical sentence of the current sentence in an article to which the current sentence belongs;

an error correction module 502 configured to perform text error correction processing on the current sentence based on the current sentence and the historical sentence.

The principle and technical effect of the text error correction apparatus 500 according to the present embodiment in implementing the text error correction by employing the above modules are the same as those of the above relevant method embodiments. For particulars, please refer to the disclosure of the above relevant method embodiments, and no detailed depictions will be presented herein.

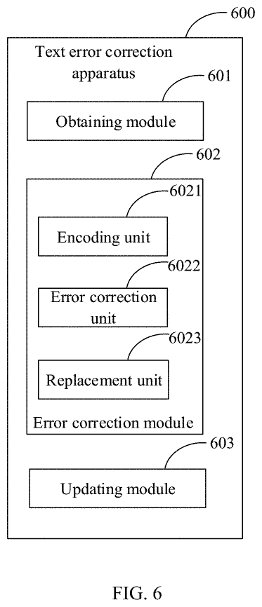

FIG. 6 illustrates a schematic diagram of a fifth embodiment according to the present disclosure; as shown in FIG. 6, a text error correction apparatus 600 according to the present embodiment further introduces the technical solution of the present application in more detail on the basis of the text error correction apparatus 500 shown in FIG. 5. An obtaining module 601 and an error correction module 602 shown in FIG. 6 respectively correspond to and have the same functions as the obtaining module 501 and error correction module 502 in FIG. 5.

As shown in FIG. 6, in the text error correction apparatus 600 of the present embodiment, the error correction module 602 is configured to: perform text error correction processing on the current sentence by using a pre-trained text error correction model, based on the current sentence and historical sentence.

Further optionally, as shown in FIG. 6, in the text error correction apparatus 600 of the present embodiment, the error correction module 602 includes an encoding unit 6021 configured to encode based on the current sentence and the historical sentence of the current sentence in the article to which the current sentence belongs, to obtain an error correction sentence corresponding to the current sentence; an error correction unit 6022 configured to detect whether the error correction sentence is consistent with the current sentence; a replacement unit 6023 configured to replace the current sentence with the error correction sentence, if the error correction sentence is not consistent with the current sentence.

Further optionally, the encoding unit 6021 is configured to: obtain a feature representation of the current sentence; obtain a state feature representation of the historical sentence; encode based on the feature representation of the current sentence and the state feature representation of the historical sentence, to obtain an encoding result; obtain the error correction sentence corresponding to the current sentence based on the encoding result.

Further optionally, as shown in FIG. 6, the text error correction apparatus 600 of the present embodiment further comprises an updating module 603 configured to: obtain a feature representation of the current sentence after the replacement; update a state feature representation of a historical sentence of next current sentence by using the feature representation of the current sentence after the replacement and the state feature representation of the historical sentence.

Further optionally, the updating module 603 is further configured to: update a state feature representation of a historical sentence of next current sentence by using the feature representation of the current sentence and the state feature representation of the historical sentence, if the error correction sentence is detected consistent with the current sentence.

The principle and technical effect of the text error correction apparatus 600 according to the present embodiment in implementing the text error correction by employing the above modules are the same as those of the above relevant method embodiments. For particulars, please refer to the disclosure of the above relevant method embodiments, and no detailed depictions will be presented herein.

According to embodiments of the present disclosure, the present disclosure further provides an electronic device and a readable storage medium.

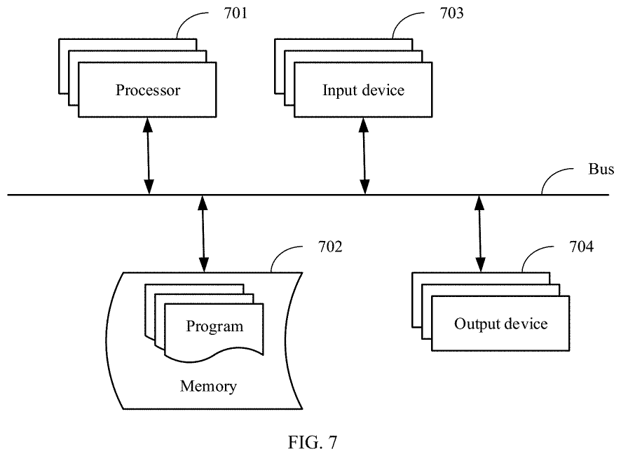

As shown in FIG. 7, it shows a block diagram of an electronic device for implementing the text error correction method according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 7, the electronic device comprises: one or more processors 701, a memory 702, and interfaces configured to connect components and including a high-speed interface and a low speed interface. Each of the components are interconnected using various buses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 701 is taken as an example in FIG. 7.

The memory 702 is a non-transitory computer-readable storage medium provided by the present disclosure. The memory stores instructions executable by at least one processor, so that the at least one processor executes the text error correction method according to the present disclosure. The non-transitory computer-readable storage medium of the present disclosure stores computer instructions, which are used to cause a computer to execute the text error correction method according to the present disclosure.

The memory 702 is a non-transitory computer-readable storage medium and can be used to store non-transitory software programs, non-transitory computer executable programs and modules, such as program instructions/modules (e.g., relevant modules shown in FIG. 4 and FIG. 5) corresponding to the text error correction method in embodiments of the present disclosure. The processor 701 executes various functional applications and data processing of the server, i.e., implements the text error correction method in the above method embodiments, by running the non-transitory software programs, instructions and modules stored in the memory 702.

The memory 702 may include a storage program region and a storage data region, wherein the storage program region may store an operating system and an application program needed by at least one function; the storage data region may store data created for use in the electronic device in implementing the text error correction method. In addition, the memory 702 may include a high-speed random access memory, and may also include a non-transitory memory, such as at least one magnetic disk storage device, a flash memory device, or other non-transitory solid-state storage device. In some embodiments, the memory 702 may optionally include a memory remotely arranged relative to the processor 701, and these remote memories may be connected to the electronic device for implementing the text error correction method through a network. Examples of the above network include, but are not limited to, the Internet, an intranet, a local area network, a mobile communication network, and combinations thereof.

The electronic device for implementing the route planning method may further include an input device 703 and an output device 704. The processor 701, the memory 702, the input device 703 and the output device 704 may be connected through a bus or in other manners. In FIG. 7, the connection through the bus is taken as an example.

The input device 703 may receive inputted numeric or character information and generate key signal inputs related to user settings and function control of the electronic device for implementing the text error correction method, and may be an input device such as a touch screen, keypad, mouse, trackpad, touchpad, pointing stick, one or more mouse buttons, trackball and joystick. The output device 704 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

According to the technical solutions of the embodiments of the present disclosure, text error correction can be performed on the current sentence based on the historical sentence, namely, the upper contextual information, of the current sentence in the article so that the error correction information is richer and the error correction result is more accurate.

Furthermore, according to the technical solutions of the embodiments of the present disclosure, the text error correction solution may be implemented based on a pre-trained text error correction model, thereby further improving the intelligence and accuracy of text error correction.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A text error correction method, wherein the method comprises:
obtaining a current sentence and a historical sentence of the current sentence in an article to which the current sentence belongs; and
performing text error correction processing on the current sentence based on the current sentence and the historical sentence.

2. The method according to claim 1, wherein the performing text error correction processing on the current sentence based on the current sentence and the historical sentence comprises:
performing text error correction processing on the current sentence by using a pre-trained text error correction model, based on the current sentence and historical sentence.

3. The method according to claim 1, wherein the performing text error correction processing on the current sentence based on the current sentence and the historical sentence comprises:
encoding based on the current sentence and the historical sentence of the current sentence in the article to which the current sentence belongs, to obtain an error correction sentence corresponding to the current sentence;
detecting whether the error correction sentence is consistent with the current sentence; and
replacing the current sentence with the error correction sentence, if the error correction sentence is not consistent with the current sentence.

4. The method according to claim 2, wherein the performing text error correction processing on the current sentence based on the current sentence and the historical sentence comprises:
encoding based on the current sentence and the historical sentence of the current sentence in the article to which the current sentence belongs, to obtain an error correction sentence corresponding to the current sentence;
detecting whether the error correction sentence is consistent with the current sentence; and
replacing the current sentence with the error correction sentence, if the error correction sentence is not consistent with the current sentence.

5. The method according to claim 3, wherein the encoding based on the current sentence and the historical sentence of the current sentence in the article to which the current sentence belongs, to obtain an error correction sentence corresponding to the current sentence comprises:
obtaining a feature representation of the current sentence;
obtaining a state feature representation of the historical sentence;
encoding based on the feature representation of the current sentence and the state feature representation of the historical sentence, to obtain an encoding result; and
obtaining the error correction sentence corresponding to the current sentence based on the encoding result.

6. The method according to claim 3, wherein after replacing the current sentence with the error correction sentence, the method further comprises:
obtaining a feature representation of the current sentence after the replacement; and
updating a state feature representation of a historical sentence of next current sentence by using the feature representation of the current sentence after the replacement and the state feature representation of the historical sentence.

7. The method according to claim 4, wherein the encoding based on the current sentence and the historical sentence of the current sentence in the article to which the current sentence belongs, to obtain an error correction sentence corresponding to the current sentence comprises:
obtaining a feature representation of the current sentence;
obtaining a state feature representation of the historical sentence;
encoding based on the feature representation of the current sentence and the state feature representation of the historical sentence, to obtain an encoding result; and
obtaining the error correction sentence corresponding to the current sentence based on the encoding result.

8. The method according to claim 4, wherein after replacing the current sentence with the error correction sentence, the method further comprises:
obtaining a feature representation of the current sentence after the replacement; and
updating a state feature representation of a historical sentence of next current sentence by using the feature representation of the current sentence after the replacement and the state feature representation of the historical sentence.

9. The method according to claim 5, wherein if the error correction sentence is detected consistent with the current sentence, the method further comprises:
updating a state feature representation of a historical sentence of next current sentence by using the feature representation of the current sentence and the state feature representation of the historical sentence.

10. The method according to claim 6, wherein if the error correction sentence is detected consistent with the current sentence, the method further comprises:
updating a state feature representation of a historical sentence of next current sentence by using the feature representation of the current sentence and the state feature representation of the historical sentence.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a text error correction method, wherein the method comprises:
obtaining a current sentence and a historical sentence of the current sentence in an article to which the current sentence belongs; and
performing text error correction processing on the current sentence based on the current sentence and the historical sentence.

12. The electronic device according to claim 11, wherein the performing text error correction processing on the current sentence based on the current sentence and the historical sentence comprises:
performing text error correction processing on the current sentence by using a pre-trained text error correction model, based on the current sentence and historical sentence.

13. The electronic device according to claim 11, wherein the performing text error correction processing on the current sentence based on the current sentence and the historical sentence comprises:
encoding based on the current sentence and the historical sentence of the current sentence in the article to which the current sentence belongs, to obtain an error correction sentence corresponding to the current sentence;
detecting whether the error correction sentence is consistent with the current sentence; and
replacing the current sentence with the error correction sentence, if the error correction sentence is not consistent with the current sentence.

14. The electronic device according to claim 12, wherein the performing text error correction processing on the current sentence based on the current sentence and the historical sentence comprises:
encoding based on the current sentence and the historical sentence of the current sentence in the article to which the current sentence belongs, to obtain an error correction sentence corresponding to the current sentence;
detecting whether the error correction sentence is consistent with the current sentence; and
replacing the current sentence with the error correction sentence, if the error correction sentence is not consistent with the current sentence.

15. The electronic device according to claim 13, wherein the encoding based on the current sentence and the historical sentence of the current sentence in the article to which the current sentence belongs, to obtain an error correction sentence corresponding to the current sentence comprises:
obtaining a feature representation of the current sentence;
obtaining a state feature representation of the historical sentence;
encoding based on the feature representation of the current sentence and the state feature representation of the historical sentence, to obtain an encoding result; and
obtaining the error correction sentence corresponding to the current sentence based on the encoding result.

16. The electronic device according to claim 13, wherein after replacing the current sentence with the error correction sentence, the method further comprises:
obtaining a feature representation of the current sentence after the replacement; and
updating a state feature representation of a historical sentence of next current sentence by using the feature representation of the current sentence after the replacement and the state feature representation of the historical sentence.

17. The electronic device according to claim 14, wherein the encoding based on the current sentence and the historical sentence of the current sentence in the article to which the current sentence belongs, to obtain an error correction sentence corresponding to the current sentence comprises:
obtaining a feature representation of the current sentence;
obtaining a state feature representation of the historical sentence;
encoding based on the feature representation of the current sentence and the state feature representation of the historical sentence, to obtain an encoding result; and
obtaining the error correction sentence corresponding to the current sentence based on the encoding result.

18. The electronic device according to claim 14, wherein after replacing the current sentence with the error correction sentence, the method further comprises:
obtaining a feature representation of the current sentence after the replacement; and
updating a state feature representation of a historical sentence of next current sentence by using the feature representation of the current sentence after the replacement and the state feature representation of the historical sentence.

19. The electronic device according to claim 16, wherein if the error correction sentence is detected consistent with the current sentence, the method further comprises:
updating a state feature representation of a historical sentence of next current sentence by using the feature representation of the current sentence and the state feature representation of the historical sentence, if the error correction sentence is detected consistent with the current sentence.

20. A non-transitory computer readable storage medium with computer instructions stored thereon, wherein the computer instructions are used for causing a computer to perform a text error correction method, wherein the method comprises:
obtaining a current sentence and a historical sentence of the current sentence in an article to which the current sentence belongs; and
performing text error correction processing on the current sentence based on the current sentence and the historical sentence.
